(19) United States
(12) Patent Application Publication
(10) Pub. No.: US 2003/0144966 A1
(43) Pub. Date: Jul. 31, 2003

(54) Computer-assisted method for outputting a data record, computer system set up for providing data records, computer-assisted method for making a data record available and client system for ordering a data record

(76) Inventors: Matthias Friedmann, Obertraubling (DE); Derrick Zechmair, Tegernheim (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/103,463

(22) Filed: Mar. 22, 2002

(30) Foreign Application Priority Data
Jan. 29, 2002 (DE) 102 03 399.4
Feb. 11, 2002 (DE) 102 05 578.5

(51) Int. Cl. G06F 17/60

(52) U.S. Cl. 705/67

(57) ABSTRACT

A computer-assisted method of outputting an operating data record intended for a use of an electrical appliance includes the step of requesting, with a client system, an operating data record for an electrical appliance from a server computer system and transmitting the operating data record to the client system in electronic form. A computer system for providing data records and a client system for ordering data records are also provided.

### BACKGROUND OF THE INVENTION

### FIELD OF THE INVENTION

The invention relates to a computer-assisted method for outputting a data record, to a computer system set up for providing data records, to a computer-assisted method for making a data record available and to a client system for ordering a data record.

The invention deals with problems that suppliers of electrical appliances for automobiles have to deal with. Automobile electronics suppliers usually manufacture electrical appliances which are used in a large number of motor vehicles and commercial vehicles and thus are highly technological and specialized products produced in large numbers.

Such electrical appliances are, by way of example, electronic engine controllers, electronic transmission controllers, electronic vehicle dynamics regulators, electronic controllers for occupant protection systems, and many others. Customers for these electrical appliances are automobile manufacturers which install and make the electrical connections between the appliances in their motor vehicles. “System suppliers” may also be purchasers of electronic controllers which then supply the automobile manufacturer with a complete system for a motor vehicle containing mechanical and electronic components. Examples of such systems are the brake system in a vehicle, the occupant protection system, etc.

An automobile supplier will usually develop and supply a basic type of such an electrical appliance for at least one vehicle platform of an automobile manufacturer. A basic type of such an electrical appliance may sometimes also be supplied and used for a plurality of an automobile manufacturer's vehicle platforms. If appropriate, basic types of control units are even developed and sold for more than one manufacturer.

An electronic control unit for a motor vehicle normally has hardware and software, and also interfaces for connecting external components. Usually, a processor is provided which processes processing code stored in a read only memory (ROM) during operation of the motor vehicle, with sensor signals supplied to the control unit usually serving as input variables for this processing code, and the control unit outputting the results of the processing code in the form of control signals to actuators.

In different automobile environments, it is usually possible without exception to use the same fundamental processing code.

Thus, by way of example, the same basic concepts of an engine controller can be used both for engines with a relatively small displacement and for engines with a relatively large displacement. The basic structure of this processing code, also called control algorithms, can thus be used for a wide variety of automobile environments. Equipment variants in vehicles are also understood as environmental conditions, which means that, for a motor vehicle, the fundamental trigger algorithm for front airbags is always the same, irrespective of whether or not side airbags are provided as equipment. If side airbags can be provided as additional equipment, the activation algorithms for these side airbags are usually also stored previously in an electronic control unit for actuating occupant protection devices, even if a vehicle leaves the assembly line with only its basic equipment, without side airbags. This processing code which is not required is usually activated by virtue of a software identifier in the form of a flag being set or not set. In the case of a vehicle equipment variant with side airbags, the associated actuation software can accordingly be activated through the use of this flag.

Thus, by way of example, such a flag content is understood as an operating data record. A threshold value for an airbag trigger algorithm which depends on the body structure in which the electrical appliance is installed can also be understood as an operating data record, however. If the body structure is relatively yielding, for example, then the threshold value needs to start relatively low, since a large degree of impact energy is actually taken up by the vehicle's crumple zone. On the other hand, hard body structures transfer an impact better and faster to a sensor provided for this purpose, which means that less severe impacts actually bring about sizeable sensor reactions.

Parameters used, by way of example, as multipliers or subtrahends (offset) in processing code are also understood as operating data records. Alternatively, operating data records can be entire families of characteristic curves which are provided for controlling actuators but need to be used on the basis of vehicle platform, for example.

Such operating parameters which differ from one another depending on the application of the electrical appliance are usually stored in a programmable memory, preferably in an EPROM or EEPROM in the electrical appliance. Before parameter sets are stored in this way, they are evaluated by the automobile supplier and are approved by the automobile manufacturer.

To date, such electronic control appliances are produced by the automobile supplier and are provided with the appropriate software—in particular the algorithmic control code—but also with the aforementioned parameters, intended for a particular use environment, as operating data records.

Accordingly, the automobile supplier provides the automobile manufacturer with an appliance which can be used immediately and has the full software, that is to say the appropriate specific operating data records as well. The automobile manufacturer then installs this electrical appliance in the vehicle type exactly intended for it.

The result of this practice is that automobile suppliers need to provide hundreds of variants of an electrical appliance having an inherently identical basic concept. This diversity of variants not only results in an increased warehousing volume, but also, in particular, entails the need for coding operations for the individual appliance variants. Throughout the supply process, it is necessary to be able to comprehend which appliance is provided with which operating data records for which vehicle model. On account of this fact, the control units need to be provided with mechanical and/or colored and/or electric codings, with each variant needing to have a clearly associatable coding.

Such a coding is not desirable. It represents an additional work step in the manufacturing process, coding lists need to be maintained, and codings per se in turn need to be monitored and taken into account.

### SUMMARY OF THE INVENTION

It is accordingly an object of the invention to provide methods and elements of a system which overcome the above-mentioned disadvantages and which avoid complex coding of appliance variants.

With the foregoing and other objects in view there is provided, in accordance with the invention, a computer-assisted method of outputting an operating data record provided for operating an electrical appliance, the method includes the steps of:

transmitting a representative of the operating data record;

receiving an order for the operating data record;

selecting an ordered operating data record from a server database; and

outputting the ordered operating data record in electronic form.

In other words, a computer-assisted method for outputting a data record, in which an operating data record intended for the use of an electrical appliance is output with the following steps:

a representative of the operating data record is transmitted;

an order for the operating data record is received;

the ordered operating data record is selected from a server database; and

the ordered operating data record is output in electronic form.

Another mode of the method according to the invention includes the preliminary steps of transmitting an authorization request; receiving a user identifier; comparing the user identifier with stored user identifiers; and transmitting the representative of the operating data record only if the user identifier matches one of the stored user identifiers.

A further mode of the method according to the invention includes the steps of providing the server database such that the server database contains links between operating data records and user identifiers; and transmitting only given ones of a plurality of representatives of operating data records, the given ones of the representatives of operating data records being linked to a user identifier of a user logged on with an authorization.

Yet another mode of the method according to the invention includes the step of transmitting representatives of all operating data records held in the server database.

Another mode of the method according to the invention includes the step of transmitting a web page as an ordering component containing the representative.

A preferred mode of the method according to the invention includes the steps of producing an invoice for the ordered operating data record.

Another mode of the method according to the invention includes the steps of keeping an electronic money account of an authorized user on a server side; and performing a debit operation on the electronic money account of the authorized user in response to one of an ordering and a delivery of the operating data record.

Yet another mode of the method according to the invention includes the step of providing different operating data records for operating the electrical appliance in different environments.

Another mode of the method according to the invention includes the step of providing the operating data record such that the operating data record contains parameters for an operation of an electronic motor vehicle control unit.

A further mode of the method according to the invention includes the step of providing different operating data records for operating a motor vehicle control unit in different motor vehicle types.

Another preferred mode of the method according to the invention includes the step of providing different operating data records for an operation of a motor vehicle control unit in motor vehicles with different equipment variants.

Another mode of the method according to the invention includes the step of providing the operating data record such that the operating data record contains parameters for an operation of an electronic control unit for a motor vehicle occupant protection device.

A further mode of the method according to the invention includes the step of providing respective different operating data records for an operation of the electronic control unit for the motor vehicle occupant protection device at respective different installation points in a motor vehicle.

The essence of the invention is that a computer-assisted client-server union is provided. A server database in the server computer system holds operating data records for the use of an electrical appliance, which operating data records can be read upon appropriate request. For this purpose, the server computer system provides an ordering component for selecting and/or for ordering at least one operating data record. This ordering component is transmitted to the client in electronic form as a result of a request by the client, and is usually a web page. The computer system also has an output device which can be used to output an ordered operating data record in electronic form.

With the objects of the invention in view there is also provided, a computer system for providing data records, including:

a server database configured to store a plurality of operating data records provided for operating an electrical appliance;

an ordering component for at least one of selecting and ordering at least one of the operating data records; and

an output device, operatively connected to the server database, for outputting an ordered one of the operating data records in electronic form.

In other words, a computer system, set up for the provision of data records, has a server database; operating data records intended for the use of an electrical appliance, which are stored in the server database; an ordering component for selecting and/or for ordering at least one operating data record; and an output device for outputting an ordered operating data record in electronic form.

According to another feature of the invention, respective different ones of the operating data records are provided for operating the electrical appliance in respective different environments.

According to yet another feature of the invention, at least one of the operating data records contains parameters for operating an electronic motor vehicle control unit.

According to another feature of the invention, respective different ones of the operating data records are provided for operating a motor vehicle control unit in respective different motor vehicle types.

According to a further feature of the invention, respective different ones of the operating data records are provided for operating a motor vehicle control unit in motor vehicles having respective different equipment variants.

According to another feature of the invention, at least one of the operating data records contains parameters for operating an electronic control unit for a motor vehicle occupant protection device.

According to a further feature of the invention, respective different ones of the operating data records are provided for operating an electronic control unit for a motor vehicle occupant protection device installed at respective different installation points in a motor vehicle.

According to a further feature of the invention, the ordering component is configured as a web page.

According to another feature of the invention, the output device includes an interface configured to be connected to a data communication line.

According to a further feature of the invention, the output device includes an interface configured to be connected to a wireless data transmission path.

According to yet another feature of the invention, a selection device is operatively connected to the server database for selecting an ordered one of the operating data records from the server database.

According to a further feature of the invention, at least a given one of the operating data records is linked to a user identifier.

According to another feature of the invention, an authorization request component is operatively connected to the server database for requesting a submission of a user identifier.

According to another feature of the invention, a checking component is operatively connected to the server database, the checking component being configured to check a supplied user identifier with stored user identifiers.

According to another feature of the invention, given ones of the operating data records are linked to a user identifier for an authorized user; and the ordering component is configured to one of select and order only the given ones of the operating data records associated with the user identifier for the authorized user.

According to yet another feature of the invention, an electronic money account is provided for debiting an amount of money for ordered ones of the operating data records or output ones of the operating data records.

With the objects of the invention in view there is also provided, a computer-assisted method of making available an operating data record provided for operating an electrical appliance, the method includes the steps of:

visualizing a representative of the operating data record on a client system of a user;

transmitting an order for the operating data record; and receiving, with the client system, an ordered operating data record transmitted in electronic form.

Another mode of the method according to the invention includes the preliminary steps of calling up an identifier for an operating data record server; and transmitting a user identifier on request.

Another mode of the method according to the invention includes the step of storing a received operating data record.

Yet another mode of the method according to the invention includes the step of writing the operating data record to a memory in the electrical appliance.

A further mode of the method according to the invention includes the step of making settings for writing to the memory, prior to performing the step of writing to the memory in the electrical appliance.

With the objects of the invention in view there is also provided, a client system for ordering a data record, including:

a display component for displaying a representative representing an operating data record provided for operating an electrical appliance;

an ordering component, operatively connected to the display component, for at least one of selecting and ordering an operating data record; and

a reception device, operatively connected to the ordering component, for receiving, in electronic form, the operating data record.

According to another feature of the invention, the client system is a computer.

According to yet another feature of the invention, a coupling device is operatively connected to the reception device for connecting the electrical appliance.

According to another feature of the invention, the reception device is configured to forward an operating data record to the coupling device.

According to a further feature of the invention, a memory is operatively connected to the reception device for storing an operating data record.

In other words, a client system according to the invention is set up such that it contains a display component for displaying at least one representative of an operating data record provided for the use of an electrical appliance. This display component is used for visually displaying the ordering component from the server-end computer system on the client system. In this case, the ordering component in the form of a datasheet or web page usually contains at least one representative of the operating data record which can be retrieved by the client system. Such a representative can be a certain shortcode for an operating data record or else can be an appropriately labeled ordering button for a particular operating data record, without the technical code of the operating data record needing to appear on the client system. Instead, merely the fact that an operating data record can be selected for the appliance X of the customer A is displayed to the client system.

Preferably, the Internet or an intranet section is used as the data communication unit between server computer system and client system, which allows the client system to select and order an operating data record over the Internet or intranet. The operating data record per se is then transmitted from the server computer system to the client system in electronic form, with the transmission medium provided again being able to be the Internet or intranet, or alternatively—for example for reasons of data security—a separate line-connected or wireless transmission link.

The server-end method according to the invention for outputting such an operating data record first involves transmitting a representative of an operating data record. Next, an order for one or more operating data records is received. The ordered operating data records are selected from the server database and are output to the client system in electronic form.

The client-end computer-assisted method according to the invention for making such an operating data record available involves visualizing a representative of the operating data record on a user's client system, transmitting an order for one or more operating data records, and the client system's receiving the ordered operating data record transmitted in electronic form.

A customer/user can thus use an appropriately set up client system to request access to a remotely provided server database on which different operating data records for electrical appliances are stored. Following a request by the client system, the server-end computer system transmits an ordering component in the form of an order form for selecting the desired operating data records. Appropriate selection on the client system transmits the order to the server-end computer system. There, the operating data records requested are selected in the server database and are transmitted to the requesting client system in electronic form via a suitable interface.

The advantages of using the system component and the method steps according to the invention are considerable: operating data records are made available as such to the purchaser of the electrical appliance directly. Electrical appliances are programmed with operating data records on the customer/user's premises. Thus, although the supplier of the electrical appliances delivers them provided with the fundamental processing code/control code stored in the electrical appliance's ROM, they are without individual parameters in the form of operating data records which make the electrical appliance serviceable for use in an intended environment. In this respect, the necessary mechanical, colored or electric coding provided previously for the logistical route from the manufacturer to the purchaser is no longer required. The electrical appliances can be delivered to the purchaser (or possibly even to a plurality of different purchasers) as identical parts equipped with the same hardware and software. Alignment of the electrical appliances with the respective appliance's operating conditions intended by the purchaser is performed by the purchaser himself by virtue of his using, upon or after receipt of the appliance, an Internet connection, for example, for electronically requesting the operating data records relevant to him from the prepared data server, and receiving them in electronic form. In addition, changes can be incorporated into current mass-produced products much more easily. Previously, this required a new appliance, usually with new connector coding, to be introduced. The introduction of this method according to the invention means that changes can be introduced directly without additional cost.

In this case, data server and client system are usually provided at a physical distance from one another, with the server-end computer system normally being provided by the manufacturer of the electrical appliances. With access authorization, purchasers/customers can then download operating data records from any location. In the case of automobile applications, such client systems are preferably set up at programming stations at the end of the assembly line in factories, or alternatively at other service stations for automobiles, for example repair shops or contractual repair shops, which can likewise program the electrical appliance in question with operating data records when required.

In this context, the use of the methods and of the systems according to the invention is not limited to the provision or furnishing of operating data records for electronic appliances for automobile use. The invention can be applied to all electrical appliances, preferably appliances having control functions, which are intended to be available on the market in a wide diversity of variants for operating parameters having the same basic functionality. In this respect, any electronic mass-produced article with equipment variants is suitable as the electrical appliance within the context of the invention.

It is advantageous if the electrical appliances can be configured such that different operating data records are provided for the use of the electrical appliance in different environments.

In an advantageous development of the invention, the operating data records contain parameters for the operation of an electronic motor vehicle control unit.

In another advantageous development of the invention, different operating data records are in this case provided for the use of the motor vehicle control unit in different motor vehicle types.

In addition or alternatively, different operating data records can be provided for the use of the motor vehicle control unit in motor vehicles having different equipment variants. One advantageous application of the invention relates to electrical appliances provided as electronic control units for motor vehicle occupant protection devices. In this context, different operating data records can be provided for the use of such occupant protection control units at different installation points in the motor vehicle. By way of example, modern occupant protection systems are provided with impact sensors as electrical appliances, which are provided on the side of the vehicle and are intended to detect a lateral impact. In this context, such an electrical appliance can be provided, by way of example, with different operating data records depending on whether it is used on the left-hand side or on the right-hand side at the edge of the vehicle in order to detect a lateral impact on the left or on the right.

In one particularly advantageous development, the ordering and/or output of an operating data record is simultaneously linked to a payment for the electrical appliance for which the operating data record has been ordered using the computer system. In this case, different measures can be provided: the ordering or output of an operating data record can bring about an automatic production of an invoice, and possibly an automatic printing of the invoice. Preferably, the server-end computer system can also be provided with an electronic money account for each user which is debited with an appropriate sum when the operating data record is ordered or output. Alternatively, the client system can also be provided with a card reader for accepting a cash card. Accordingly, this cash card is then debited as appropriate when operating data records are ordered or received.

Other features which are considered as characteristic for the invention are set forth in the appended claims.

Although the invention is illustrated and described herein as embodied in a computer-assisted method for outputting a data record, a computer system set up for providing data records, a computer-assisted method for making a data record available and a client system for ordering a data record, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a computer system with a server-end computer system and with a client system according to the invention;

FIG. 2 is a further block diagram illustrating a system as shown in FIG. 1;

FIG. 3 is a block diagram of a computer system according to the invention, set up to provide data records, for illustrating hardware components;

FIG. 4 is a block diagram of a client system according to the invention for illustrating the hardware components;

FIG. 5 is a block diagram of a system as shown in FIG. 1 with a data interchange; and

FIG. 6 is a flowchart for the client-end and server-end methods according to the invention.

### DESCRIPTION OF THE PREFERRED EMBODIMENTS

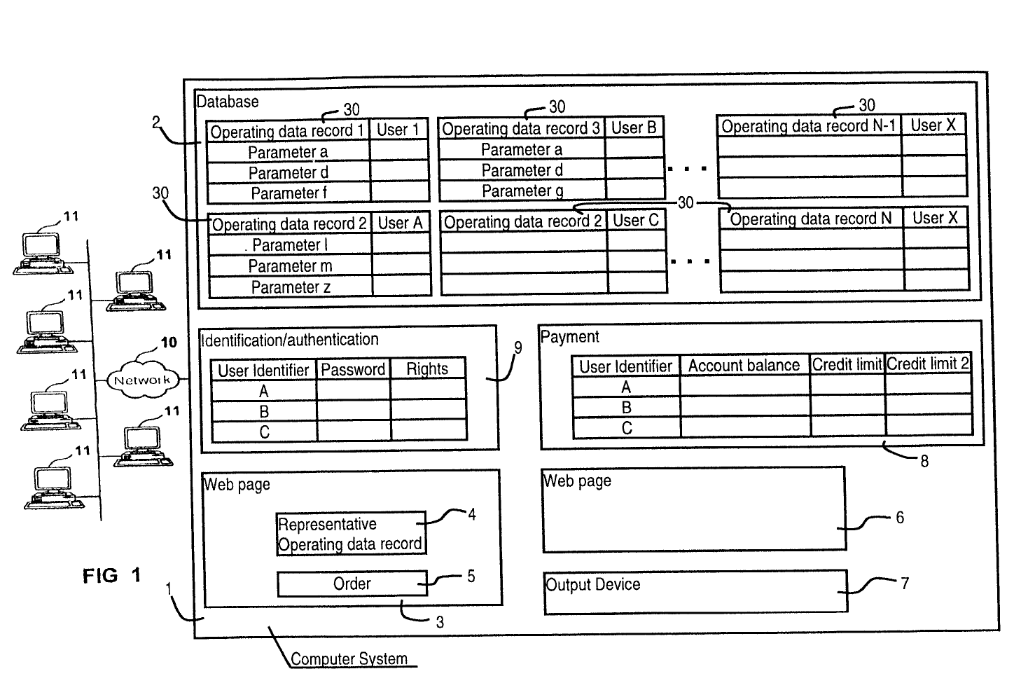

Referring now to the figures of the drawings in detail and first, particularly, to FIG. 1 thereof, there is shown a client-server system with a server-end computer system 1 to which client systems 11, shown as a computer with a screen and a keyboard, are connected in a suitable manner via a network 10. Identical reference symbols indicate identical elements in the figures. The server-end computer system 1 according to the invention contains a server database 2 storing various operating data records 30. In this case, each operating data record 30 is necessary for operating an electrical appliance in a prescribed manner. In the exemplary embodiment, each operating data record 30 is made up of the data for a plurality of parameters which—once programmed into the electrical appliance—produce a mode of operation for this electrical appliance. The figure explicitly shows the operating data records 1 to 4 in the server database symbolically, where—as indicated—up to n operating data records have been stored in the memory of the server database 2.

In a particular manner, each operating data record has an associated item of user data, which means that a link is produced which signifies that the operating data record No. x has been created, evaluated and provided for the purchaser of the electrical appliance/user y.

The computer system 1 also contains an identification block 9 storing individual users of the server database with a user identifier and also a password and rights granted by the operator of the computer system 1. The identification block 9 is used for enabling users logging on to be identified, for allowing them access to the operating data records 30 upon authorization through the use of a suitable user identifier and a password, and for granting them defined rights for using the computer system 1.

The computer system 1 also contains an electronic money account 8 storing an account balance and credit limits on a user-dependent basis. The electronic money account 8 is used for account management and automatic debiting of acquisition costs for the previously delivered electrical appliances following request for or delivery of operating data records associated with the electrical appliances.

The computer system 1 also contains an ordering component 3 in the form of a web page. This ordering component 3 is output to the client system, provided that the URL (Uniform Resource Locator) of the computer system 1 is called or else a particular request from the client system 11 has been received. The ordering component 3 in the form of a graphical interface contains a representative of an operating data record 4 or else a plurality of representatives of operating data records and also an ordering field as its content. When it is displayed on a client system 11, the ordering component 3 is intended to allow the user of the client system 11 to identify which operating data records are offered to him for selection for ordering and to order one or more desired operating data records using the ordering field 5. In this case, an operating data record is described primarily by text, such as: “operating data record for engine controller, type x for use in vehicle y of make z”.

The computer system 1 also contains an authorization request component in the form of a web page which, preferably when the URL of the computer system 1 is initially called, is transmitted to the client system 11 by the computer system 1 and contains an input mask for a user identifier and possibly a password.

Finally, reference number 7 identifies an output device which is used to output ordered operating data records 30 from the computer system 1 to the client system 11. In this case, the output device 7 can likewise access the network 10 when the operating data records 30 are output in electronic form via the same network 10 as is also used to order the operating data records 30.

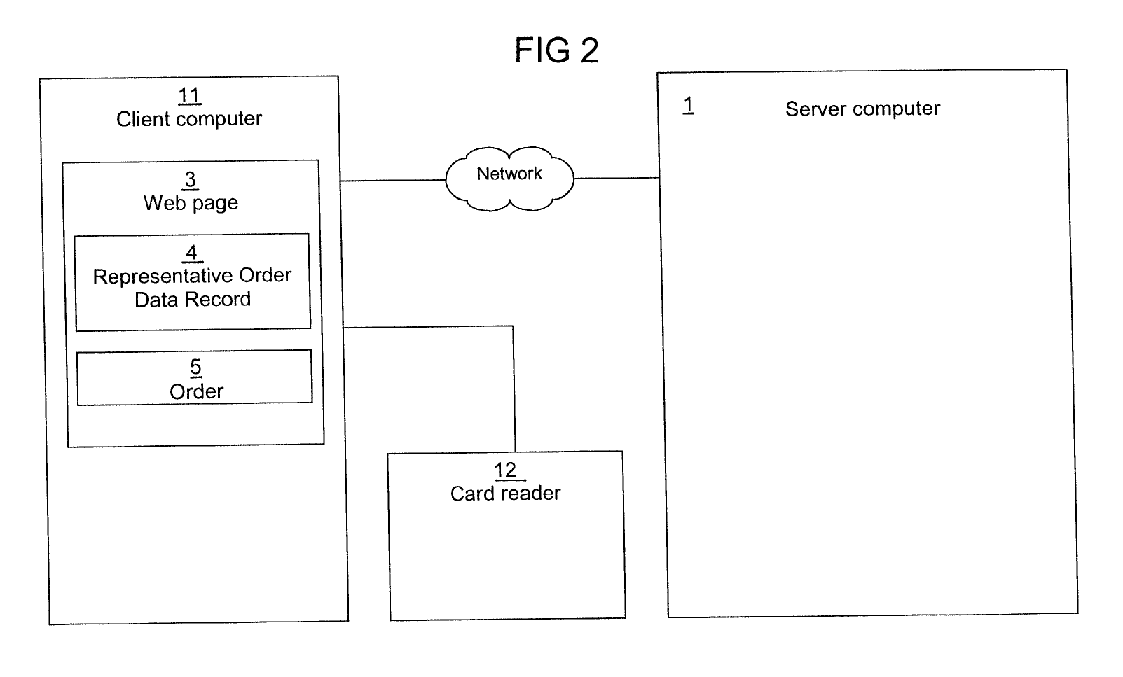

FIG. 2 shows the system shown in FIG. 1, with the client system 11 being shown in detail in a particular operating state. The computer system 1 corresponds to that from FIG. 1. The client system 11 is shown in the state of displaying an ordering component 3, transmitted by the computer system 1 via the network 10, with one or more representatives of order data records 4 and an ordering field 5. This illustration thus also provides a certain time reference for the methods according to the invention, since visual display of the ordering component 3 in the client system 11 occurs after this ordering component 3 has been transmitted by the computer system 1 on request.

As additional hardware, a card reader 12 can be connected to the client system 11. Such a card reader can be used for accepting a cash card on which an invoice total is logged for electronic appliances. In this case, the logging is no longer performed when the electrical appliances having identical parts are delivered, but rather only when operating data records are requested for starting up the electrical appliances already obtained on the customer's premises.

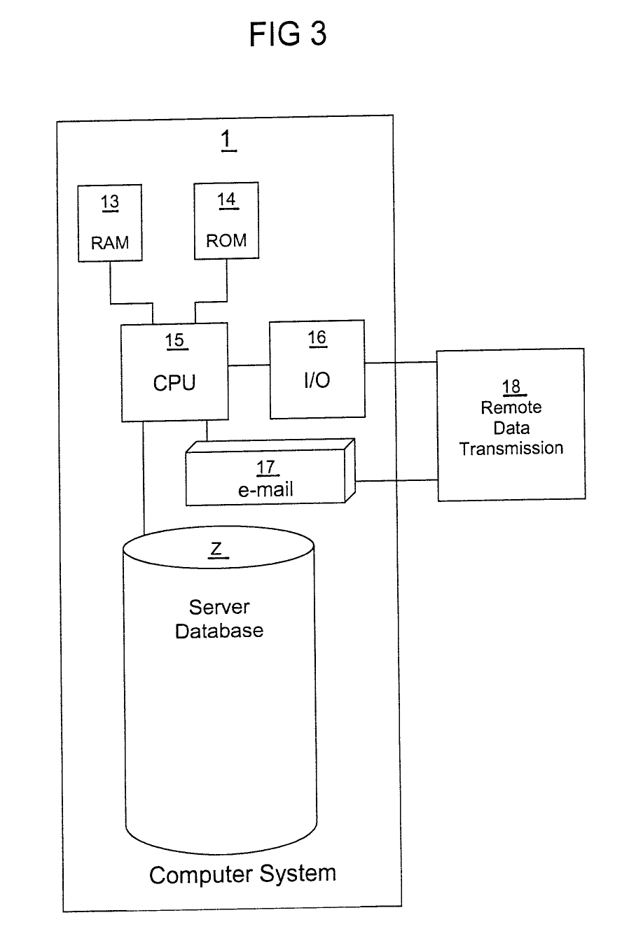

FIG. 3 shows a block diagram of a computer system according to the invention with its fundamental hardware components RAM (Random-Access Memory) 13, ROM (Read-Only Memory) 14, CPU 15, interface 16, and server database 2. The interface 16 is connected to a data communication medium (remote data transmission) 18. Requests regarding operating data records stored in the server database 2 are supplied to the CPU (Central Processing Unit) 15 via the interface 16. On the basis of processing codes stored in the memories 13 and 14, such requests are handled in such a way that the operating data records ordered are selected from the server database 2 and are supplied to the bi-directional interface 16, for example, via which they are then put into the data communication medium 18. Alternatively, the selected operating data records can also be automatically packed as electronic mail and can be mailed in the form of an e-mail to an e-mail address, for the user requesting the operating data records, via an e-mail processor 17 which is likewise connected to the data communication medium 18. If appropriate, the server database 2 is provided with a data field having associations between user e-mail addresses and users for this purpose.

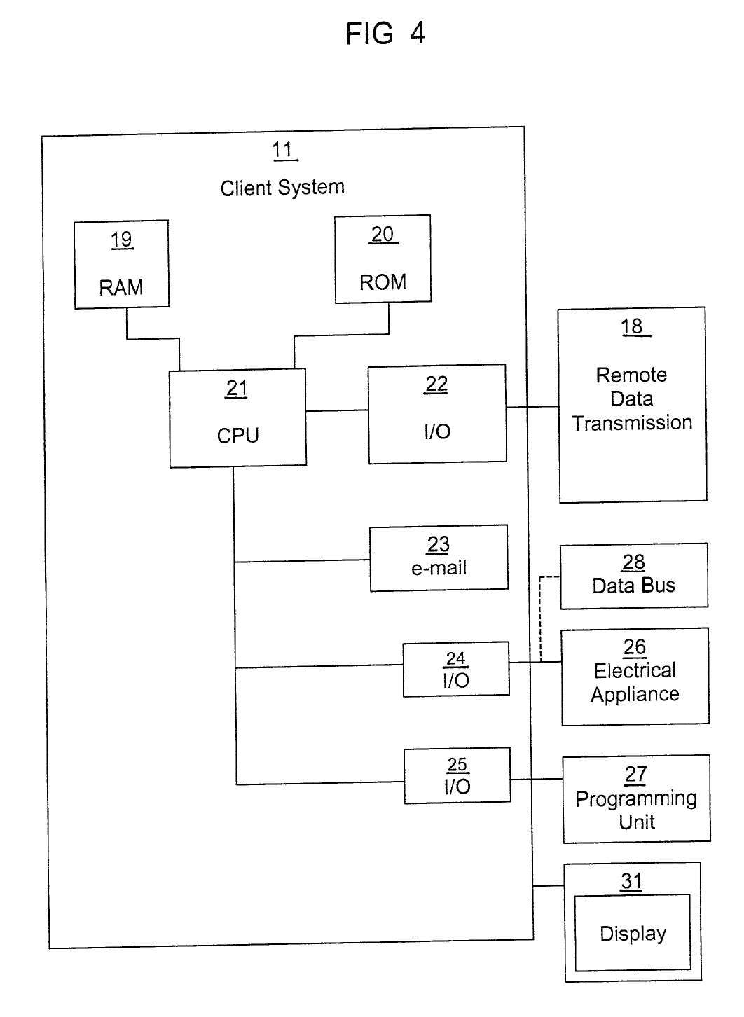

FIG. 4 shows a block diagram of a client system 11 with its fundamental hardware components. The client system 11 is also preferably based on a processor/CPU 21 with associated memories RAM 19 and ROM 20. The client system is also connected via an interface 22 to the data communication medium 18, which can be used to receive ordering components and other data from the server-end computer system 1. The programs stored in memories 19 and 20, such as browsers, make it possible to carry out the method according to the invention. Preferably, an e-mail processor 23 is provided which is likewise connected to the data communication medium 18 and can receive e-mails containing the requested operating data records. Alternatively, the ordered operating data records can naturally be transmitted directly to the interface 22 irrespective of the presence of an e-mail system for the data communication medium 18 (download mode).

Another interface 25 can be provided to which a programming unit 27 can be connected. This programming unit 27 can in turn have the electrical appliance in question connected to it. Thus, the further interface 25 can be used to transmit the appropriate operating data record to the programming unit 27, where the operating data record can be buffer-stored before the electrical appliance is programmed using the programming unit 27. In this case, the programming unit 27 can be in the form of a programming unit which can be used on a mobile basis and, once fed with appropriate operating data records, is connected to control units, for example already installed in the motor vehicle as well, for the purpose of transferring the operating data records.

In another variant, the electrical appliance 26 is connected directly to an interface 24 in the client system 11, so that the operating data records received via the data communication medium 18 can be forwarded directly to the electrical appliance 26. Instead of the electrical appliance, it is also possible to connect a data bus 28 to this interface 24. This data bus 28 is preferably a data bus in the vehicle to which the electrical appliance 26 needing to be provided with the operating data record is connected in turn in addition to other electrical appliances having other control functions. This programs the electrical appliance 26 while the vehicle data bus is interposed. In this case, the programming unit 27 can naturally also be interposed. A display component 31 is provided for displaying a representative of an operating data record.

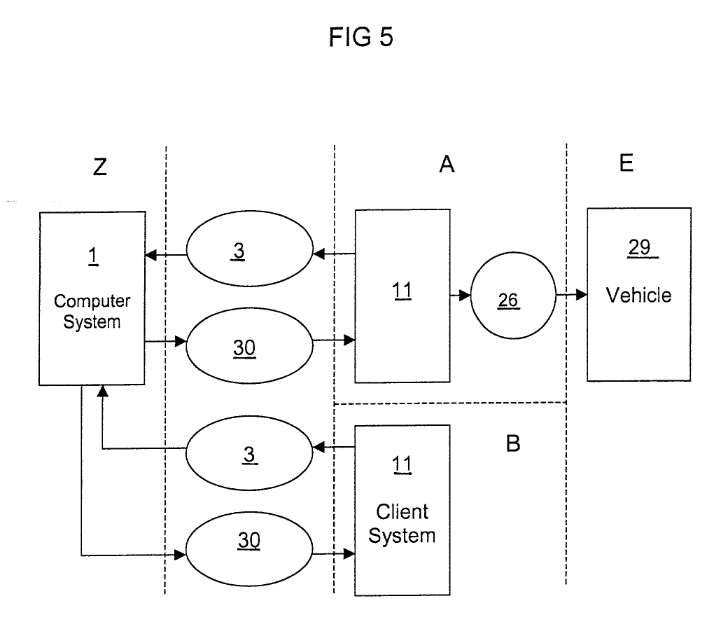

FIG. 5 shows a schematic system as shown in FIG. 1, together with data flow paths, where, again, reference numeral 1 shows a computer system with a server database, reference numeral 11 shows a client system, reference numeral 26 shows an electrical appliance to be programmed and reference numeral 29 shows a vehicle in which the electrical appliance 26 is being installed. Between the client system 11 and the server-end computer system 1, a data interchange is indicated which firstly involves an ordering component 3 being transmitted to the computer system 1 with the order for selected operating data records. In response, the server-end computer system 1 transmits the appropriate operating data records 30. Areas of association are shown separated from one another by dashed lines: the region Z characterizes an automobile supplier looking after the server-end computer system 1. By contrast, the client systems 11 are available once on the premises of the automobile manufacturer A, and another time on the premises of the user B, for example an automobile workshop. E characterizes the end consumer to whom the vehicle 29 with the then programmed electrical appliance 26 is available.

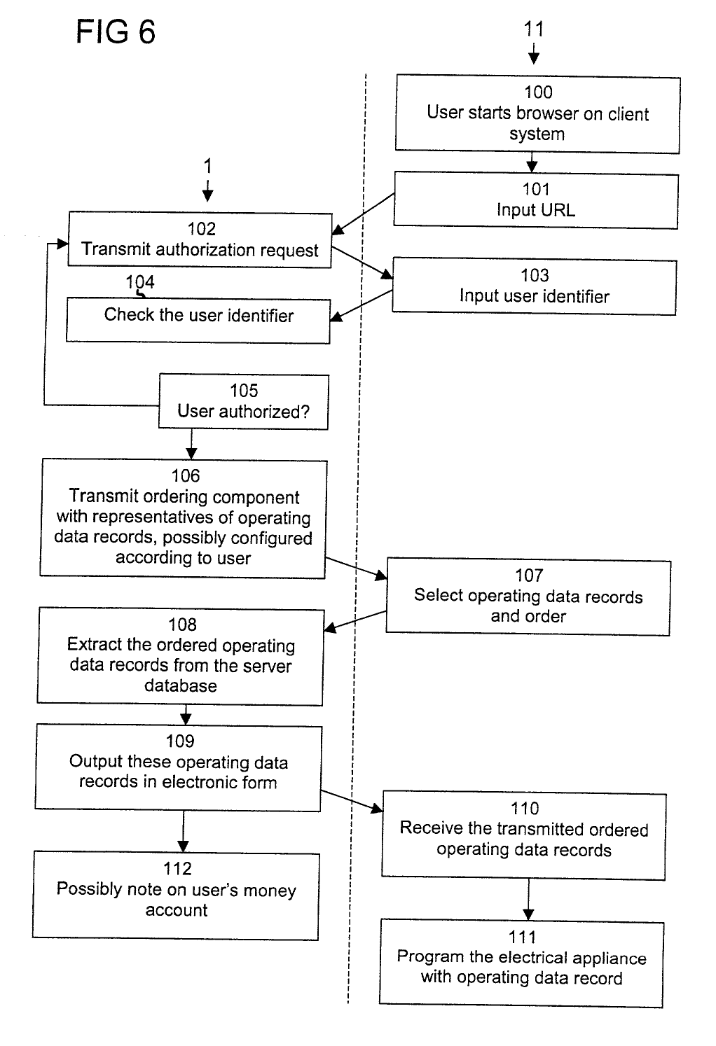

FIG. 6 shows a flowchart in which the individual method steps with increasing numbering are normally also executed successively in time. In addition, the method steps are associated in groups with the client system 11 and with the server-end computer system 1.

In step 100, the user first starts a browser on the client system 11. He then inputs in the browser a URL, characterizing the database server 1, in step 101. In step 102, the computer system 1 then transmits an authorization request to the calling client system 11. In step 103, the user of the client system 11 inputs his user identifier and sends it to the computer system 1. In step 104, the computer system 1 checks the user identifier which has been input with known user identifiers and/or passwords stored in the identification block 9. If a user logging on is identified as matching a registered user in step 105 as a result of a positive comparison result, then the process continues with step 106. If the user inputs cannot be associated with any registered user, then further access to the data in the computer system 1 is refused, and possibly another authorization request is transmitted to the requesting client system 11.

In step 106, an ordering component is transmitted to the client system 11 with representatives of operating data records. In this context, provision can preferably be made for only those operating data records or their representatives which are actually provided for the user who is logged on to be displayed in the ordering component for the client system 11. In this regard, the server database 2 thus outputs the operating data records provided with the currently requesting user identifier.

In step 107, the user selects one or more of the offered operating data records on the client system and orders them. In this case, the ordering component is transmitted back to the computer system 1 with the selection which has been made. In step 108, the computer system 1 extracts the ordered operating data records from the server database 2 and outputs these operating data records in electronic form to the client system 11 (step 109), which receives these operating data records in step 110 before the electrical appliances are programmed with these operating data records in a step 111.

If appropriate, when an electronic money account has been set up, an appropriate sum can be debited when the operating data records have been output.

We claim:

1. A computer-assisted method of outputting an operating data record provided for operating an electrical appliance, the method which comprises:
transmitting a representative of the operating data record;
receiving an order for the operating data record;
selecting an ordered operating data record from a server database; and
outputting the ordered operating data record in electronic form.

2. The computer-assisted method according to claim 1, which comprises the following preliminary steps:
transmitting an authorization request;
receiving a user identifier;
comparing the user identifier with stored user identifiers; and
transmitting the representative of the operating data record only if the user identifier matches one of the stored user identifiers.

3. The computer-assisted method according to claim 1, which comprises:
providing the server database such that the server database contains links between operating data records and user identifiers; and
transmitting only given ones of a plurality of representatives of operating data records, the given ones of the representatives of operating data records being linked to a user identifier of a user logged on with an authorization.

4. The computer-assisted method according to claim 1, which comprises transmitting representatives of all operating data records held in the server database.

5. The computer-assisted method according to claim 1, which comprises transmitting a web page as an ordering component containing the representative.

6. The computer-assisted method according to claim 1, which comprises producing an invoice for the ordered operating data record.

7. The computer-assisted method according to claim 1, which comprises:
keeping a server-end electronic money account of an authorized user; and
performing a debit operation on the electronic money account of the authorized user in response to one of an ordering and a delivery of the operating data record.

8. The computer-assisted method according to claim 1, which comprises providing different operating data records for operating the electrical appliance in different environments.

9. The computer-assisted method according to claim 1, which comprises providing the operating data record such that the operating data record contains parameters for an operation of an electronic motor vehicle control unit.

10. The computer-assisted method according to claim 1, which comprises providing different operating data records for operating a motor vehicle control unit in different motor vehicle types.

11. The computer-assisted method according to claim 1, which comprises providing different operating data records for an operation of a motor vehicle control unit in motor vehicles with different equipment variants.

12. The computer-assisted method according to claim 1, which comprises providing the operating data record such that the operating data record contains parameters for an operation of an electronic control unit for a motor vehicle occupant protection device.

13. The computer-assisted method according to claim 12, which comprises providing respective different operating data records for an operation of the electronic control unit for the motor vehicle occupant protection device at respective different installation points in a motor vehicle.

14. A computer system for providing data records, comprising:
a server database configured to store a plurality of operating data records provided for operating an electrical appliance;
an ordering component for at least one of selecting and ordering at least one of said operating data records; and
an output device, operatively connected to said server database, for outputting an ordered one of said operating data records in electronic form.

15. The computer system according to claim 14, wherein respective different ones of said operating data records are provided for operating the electrical appliance in respective different environments.

16. The computer system according to claim 14, wherein at least one of said operating data records contains parameters for operating an electronic motor vehicle control unit.

17. The computer system according to claim 14, wherein respective different ones of said operating data records are provided for operating a motor vehicle control unit in respective different motor vehicle types.

18. The computer system according to claim 14, wherein respective different ones of said operating data records are provided for operating a motor vehicle control unit in motor vehicles having respective different equip ment variants.

19. The computer system according to claim 14, wherein at least one of said operating data records contains parameters for operating an electronic control unit for a motor vehicle occupant protection device.

20. The computer system according to claim 14, wherein respective different ones of said operating data records are provided for operating an electronic control unit for a motor vehicle occupant protection device installed at respective different installation points in a motor vehicle.

21. The computer system according to claim 14, wherein said ordering component is configured as a web page.

22. The computer system according to claim 14, wherein said output device includes an interface configured to be connected to a data communication line.

23. The computer system according to claim 14, wherein said output device includes an interface configured to be connected to a wireless data transmission path.

24. The computer system according to claim 14, including a selection device, operatively connected to said server database, for selecting an ordered one of said operating data records from said server database.

25. The computer system according to claim 14, wherein at least a given one of said operating data records is linked to a user identifier.

26. The computer system according to claim 14, including an authorization request component, operatively connected to said server database, for requesting a submission of a user identifier.

27. The computer system according to claim 14, including a checking component, operatively connected to said server database, said checking component being configured to check a supplied user identifier with stored user identifiers.

28. The computer system according to claim 14, wherein:
given ones of said operating data records are linked to a user identifier for an authorized user; and
said ordering component is configured to one of select and order only the given ones of said operating data records associated with the user identifier for the authorized user.

29. The computer system according to claim 14, including an electronic money account for debiting an amount of money for one of ordered ones of said operating data records and output ones of said operating data records.

30. A computer-assisted method of making available an operating data record provided for operating an electrical appliance, the method which comprises:
visualizing a representative of the operating data record on a client system of a user;
transmitting an order for the operating data record; and
receiving, with the client system, an ordered operating data record transmitted in electronic form.

31. The computer-assisted method according to claim 30, which comprises the following preliminary steps:
calling up an identifier for an operating data record server; and
transmitting a user identifier on request.

32. The computer-assisted method according to claim 30, which comprises storing a received operating data record.

33. The computer-assisted method according to claim 30, which comprises writing the operating data record to a memory in the electrical appliance.

34. The computer-assisted method according to claim 33, which comprises making settings for writing to the memory, prior to performing the step of writing to the memory in the electrical appliance.

35. A client system for ordering a data record, comprising:
a display component for displaying a representative representing an operating data record provided for operating an electrical appliance;
an ordering component, operatively connected to said display component, for at least one of selecting and ordering an operating data record; and
a reception device, operatively connected to said ordering component, for receiving, in electronic form, the operating data record.

36. The client system according to claim 35, wherein said display component, said ordering component, and said reception component form a computer system.

37. The client system according to claim 35, including a coupling device, operatively connected to said reception device, for connecting the electrical appliance.

38. The client system according to claim 37, wherein said reception device is configured to forward an operating data record to said coupling device.

39. The client system according to claim 35, including a memory, operatively connected to said reception device, for storing an operating data record.
